(19) United States
(12) Patent Application Publication
(10) Pub. No.: US 2025/0351834 A1
(43) Pub. Date: Nov. 20, 2025

(54) INSECT CONTROL PRODUCT FOR ANIMALS

(71) Applicant: Pouch Pac Innovations, LLC, Sarasota, FL (US)

(72) Inventors: R. Charles Murray, Sarasota, FL (US); John Harlin, Sarasota, FL (US)

(21) Appl. No.: 19/207,580

(22) Filed: May 14, 2025

Related U.S. Application Data
(60) Provisional application No. 63/647,668, filed on May 15, 2024.

(51) Int. Cl. A01N 65/28; A01N 25/06; A01N 31/02; A01N 65/22

(52) U.S. Cl. CPC A01N 65/28; A01N 25/06; A01N 31/02; A01N 65/22

(57) ABSTRACT

An insect repellent composition for animals is disclosed. The insect repellent composition includes plant-based active ingredients and inert ingredients. The active ingredients include geraniol, clove oil, peppermint oil, and rosemary oil. The inert ingredients include mineral oil, isopropyl myristate, isopropyl alcohol, oleic acid, lauric acid, triethyl citrate, ethyl lactate, and vanillin.

### CROSS-REFERENCE TO RELATED APPLICATIONS

This application claims priority to U.S. Prov. Pat. App. No. 63/647,668 filed on May 15, 2024, the contents of which are hereby incorporated by reference in its entirety.

### FIELD OF THE INVENTION

The present disclosure is directed to a formulation for a topical insect repellant for animals. More particularly, the present disclosure is directed towards a non-toxic insect repellant and/or control formulation for animals (e.g., cats, dogs, horses, and other barn animals) that contains plant-based active ingredients.

### BACKGROUND OF THE INVENTION

Insect bites often cause annoying reactions in animals. Additionally, insect bites are a vector for many types of disease including: malaria, Dengue Fever, Chikungunya, West Nile and Zika viruses as well as other forms of disease.

There is a need to prevent insects from biting a host (e.g., horse, dog, cat, etc.) to lessen the discomfort of a bite reaction and to prevent the potential spread of a disease. Moreover, there is a need for a safe and effective product to keep animals relaxed and protected from biting insects.

Traditional insect repellents commonly rely on synthetic active compounds such as N,N-Diethyl-meta-toluamide (DEET) and pyrethroids (e.g., permethrin, cypermethrin). These chemicals present a number of concerns including skin irritation, toxicity to mammals upon repeated exposure, potential carcinogenicity, and environmental persistence. These formulations may also degrade rapidly under ambient conditions or require frequent reapplication, limiting their long-term efficacy.

In response to these limitations, there has been growing demand for insect control solutions that are both effective and safe for use on animals. Particularly desirable are products that are non-toxic to mammals, environmentally friendly, and derived from naturally occurring ingredients. However, many commercially available natural repellents suffer from poor residual activity, limited insecticidal efficacy, or suboptimal delivery when applied topically to fur-covered animals.

Accordingly, a natural non-toxic ingredient based topical product that prevents bites to animals would be desirable.

### SUMMARY OF THE INVENTION

An object of the disclosure is to provide a safe, non-toxic (to mammals) insect control composition that is effective in killing biting insects and ticks and that will not harm the environment.

The disclosed composition/formulation leverages synergistic interactions among terpenoids, phenolic compounds, and natural oils to achieve broad-spectrum repellency and residual activity. The composition demonstrates unexpected persistence and efficacy despite the absence of conventional synthetic stabilizers or toxicants.

In one aspect, there is disclosed a topical insect repellant composition for animals including active and inert ingredients. The active ingredients include geraniol, clove oil, peppermint oil, and rosemary oil. The inert ingredients include mineral oil, isopropyl myristate, isopropyl alcohol, oleic acid, lauric acid, triethyl citrate, ethyl lactate, and vanillin. The provision of plant-based active ingredients in the form of geraniol, clove oil, peppermint oil, and rosemary oil provides a non-toxic poison that is safe to humans/animals and effective in repelling and controlling (e.g., killing) biting insects (e.g., gnats, horse flies, mosquitoes) and ticks.

The composition can have geraniol in amounts ranging from 2.2% to 6.2% by weight, clove oil from 1% to 5% by weight, peppermint oil from 0.5% to 3.5% by weight, and rosemary oil from 0.5% to 3.5% by weight.

In some examples, the composition may contain geraniol in amounts from 3.2% to 5.2% by weight, clove oil from 2% to 4% by weight, peppermint oil from 1.5% to 2.5% by weight, and rosemary oil from 1.5% to 2.5% by weight.

The composition can include mineral oil in amounts from 33% to 63% by weight, isopropyl myristate from 13% to 33% by weight, isopropyl alcohol from 4% to 10% by weight, oleic acid from 3% to 9% by weight, lauric acid from 1% to 3% by weight, triethyl citrate from 1% to 2% by weight, ethyl lactate from 0.5% to 1.5% by weight, and vanillin from 0.2% to 0.4% by weight.

In some examples, the composition may have mineral oil in amounts from 40% to 60% by weight, isopropyl myristate from 17% to 28% by weight, isopropyl alcohol from 6% to 8% by weight, oleic acid from 5% to 7% by weight, lauric acid from 1.5% to 2.5% by weight, triethyl citrate from 1.25% to 1.75% by weight, ethyl lactate from 0.75% to 1.25% by weight, and vanillin from 0.29% to 0.31% by weight.

Additional features and advantages of the insect repellant formulation described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein and together with the description serve to explain the principles and operations of the claimed subject matter.

### DETAILED DESCRIPTION OF THE EMBODIMENTS

In one aspect, there is disclosed herein an insect repellent formulation/composition for animals formed from plant-based active ingredients. The insect repellent composition may be a topical product (e.g., a spray) applied to barn animals (e.g., horses, cows, cats, dogs, etc.) as an insecticide and tick spray. The formulation contains no harsh chemicals (e.g., no pyrethrins and DEET-free) and formed from natural eco-friendly ingredients.

### Example

In one aspect, the insect repellent formulation for animals may include the ingredients shown in TABLE 1:

TABLE 1

| | | PERCENT |
|---|---|---|
| | PERCENTAGE | RANGE |
| ACTIVE | | |
| INGREDIENTS | | |
| Geraniol | 4.2 | PLUS- |
| | | MINUS |
| | | 2% |
| Clove Oil | 3 | PLUS- |
| | | MINUS |
| | | 2% |
| Peppermint Oil | 2 | PLUS- |
| | | MINUS |
| | | 1.5% |
| Rosemary Oil | 2 | PLUS- |
| | | MINUS |
| | | 1.5% |
| INERT | | |
| INGREDIENTS | | |
| Mineral Oil | 48 | PLUS- |
| | | MINUS |
| | | 15% |
| Isopropyl | 23 | PLUS- |
| Myristate | | MINUS |
| | | 10% |
| Oleic Acid | 6 | PLUS- |
| | | MINUS |
| | | 3% |
| Isopropyl | 7 | PLUS- |
| Alcohol | | MINUS |
| | | 3% |
| Lauric Acid | 2 | PLUS- |
| | | MINUS |
| | | 1% |
| Triethyl Citrate | 1.5 | PLUS- |
| | | MINUS |
| | | 0.5% |
| Ethyl Lactate | 1 | PLUS- |
| | | MINUS |
| | | 0.5% |
| Vanillin | 0.3 | PLUS- |
| | | MINUS |
| | | 0.1% |

As specified above, the insect repellent and/or control composition/formulation includes active ingredients and inert ingredients. The active ingredients may include, or consist of, geraniol, clove oil, peppermint oil, and rosemary oil. The inert ingredients may include, or consist of, mineral oil, isopropyl myristate, isopropyl alcohol, oleic acid, lauric acid, triethyl citrate, ethyl lactate, and vanillin.

The active ingredients are plant based and non-toxic (to mammals). Geraniol is a natural terpenoid alcohol derived from citronella, rose, and palmarosa oils. Geraniol acts as broad-spectrum insect repellent, effective against mosquitoes, fleas, ticks, and stable flies, has a low toxicity profile that makes it suitable for use on animals, and provides a residual repellency effect, allowing for prolonged repellent activity. Clove oil contains phenolic compounds and demonstrates insecticidal and repellent properties, and acts quickly on contact with insects, providing fast knockdown effects. Peppermint oil acts as an insect repellant and contains menthol and menthone, which act as sensory irritants to insects. Peppermint oil provides a strong cooling effect and has analgesic and anti-inflammatory properties, offering relief at bite sites. Rosemary oil acts as an insect repellent and insect growth regulator, affecting the developmental cycles of fleas and ticks, through compounds like 1,8-cineole, camphor, and alpha-pinene. The rosemary oil also provides anti-inflammatory and antioxidant support to protect the animal's skin.

The geraniol has lipophilic properties, facilitating its adhesion to animal skin, synergistically improving the volatility and release of the other active ingredients like clove and peppermint oil. The clove oil may potentiate terpenoids within the composition through membrane-disruptive actions, enhancing overall repellent efficacy. Clove oil, when combined with geraniol and peppermint oil, helps masks the host's scent, thereby disrupting insect tracking, through its sharp or spicy aroma. The peppermint oil synergistically enhances the volatility and sensory deterrence of the other active ingredients through its strong olfactory profile. Further, the combination of peppermint oil, geraniol, and rosemary oil provides a multi-tiered defense against insects including olfactory disruption, contact irritation, and membrane damage. Rosemary oil blends together with geraniol and peppermint oil to synergistically create a broad-spectrum vapor barrier. The rosemary oil, through its oxidative stability, helps preserve more volatile active ingredients like peppermint oil or clove oil, enhance product shelf life.

Through the combination of geraniol, clove oil, peppermint oil, and rosemary oil, the insect repellant composition provides a multi-pathway repellant action by combining terpenoids (geraniol, rosemary oil), phenolics (clove oil), and ketones (peppermint oil) to disrupt insect sensory systems through multiple mechanisms. The inclusion of peppermint oil provides enhanced volatility and dispersion, improving evaporation rates and dispersal to aid in atmospheric repellency. Geraniol and clove oil work together to provide improved adhesion and residual effect, increasing retention on animal fur and skin. The peppermint oil and rosemary oil provide complementary therapeutic effects including anti-inflammatory and antimicrobial properties that may reduce irritation from bites and promote skin health and healing.

The geraniol may be present in an amount of from 2.2% to 6.2% by weight, particularly from 3.2% to 5.2% by weight. The clove oil may be present in an amount of from 1% to 5% by weight, particularly from 2% to 4% by weight. The peppermint oil may be present in an amount of 0.5% to 3.5% by weight, particularly from 1.5% to 2.5% by weight. The rosemary oil may be present in an amount of 0.5% to 3.5% by weight, particularly from 1.5% to 2.5% by weight.

The inert ingredients are non-toxic and generally regarded as safe (GRAS). The inert ingredients function to facilitate formulation of the composition and enhance the effectiveness of the active ingredients. A summary of the benefits and roles of the inert ingredients is found in TABLE 2:

| Ingredient | Function/Benefit | Role |
|---|---|---|
| Mineral Oil | Emollient and solvent | Enhances residence time of active |
| | Creates a thin, occlusive | ingredients (geraniol, clove oil, |
| | barrier on the skin or fur | rosemary oil, peppermint oil) on |
| | Reduces evaporation of | the skin |
| | volatile ingredients | Improves spreadability |
| Isopropyl Myristate | Penetration enhancer | Facilitates dermal delivery |
| (IPM) | Emollient | of active ingredients |
| | Improves skin feel and | Reduces greasy residue from |
| | absorption | mineral oil |
| Isopropyl Alcohol | Solvent for active | Enhances volatilization and initial |
| (IPA) | ingredients | release of active ingredients |
| | Aids in quick drying | Helps dissolve vanillin and active |
| | Provides short-term | ingredients |
| | antimicrobial effect | |
| Oleic Acid | Skin permeation enhancer | Synergizes with IPM to increase |
| | Surfactant-like properties | dermal penetration of terpenes |
| | Helps stabilize solution | Aids emulsification |
| Lauric Acid | Mild antimicrobial | Contributes to microbial control |
| | Functions as an emulsifier | when combined with clove or |
| | and skin conditioner | rosemary oil |
| | | Adds mild surfactancy |
| Triethyl Citrate | Solvent and fragrance | Stabilizes aroma compounds |
| | fixative | (vanillin, peppermint) |
| | pH stabilizer | May prolong scent retention |
| | Reduces enzymatic odor | for repellency |
| | breakdown | |
| Ethyl Lactate | Biodegradable solvent | Helps solubilize active ingredients |
| | Skin-penetration enhancer | and enhance efficacy through dermal |
| | Mild antimicrobial | absorption |
| | properties | |
| Vanillin | Fragrance modifier and | Synergizes with clove and peppermint |
| | fixative | to improve olfactory masking |
| | May help mask the odor | Enhances scent longevity |
| | of other ingredients | |
| | Mild insect deterrent on | |
| | its own | |

From the above, the inert ingredients provide enhancements and synergistic qualities to the overall composition. Mineral oil, IPM, and oleic acid form a semi-occlusive layer, reducing evaporation of the volatile active ingredients while improving penetration to enhance skin and fur retention of the repellant composition. Improved delivery and volatility may be provided, where IPA and ethyl lactate help in rapid dispersal and immediate efficacy, while oleic acid and IPM facilitate deep skin or fur contact for prolonged repellency. Fragrance stabilization may be enhanced by triethyl citrate and vanillin, which act as fixatives, allowing aromatic active ingredients such as geraniol and peppermint oil to linger longer and remain effective as olfactory repellents. Lauric acid and IPA provide secondary antimicrobial benefits, reducing irritation or infection risk from insect bites. Oleic acid and lauric acid contribute to emulsification and overall physical stability for formulation stability.

The (white) mineral oil may be present in an amount of from 33% to 63% by weight, particularly from 40% to 60% by weight, more particularly from 45% to 55% by weight. The isopropyl myristate may be present in an amount of from 13% to 33% by weight, particularly from 17% to 28% by weight, more particularly from 20% to 26% by weight. The isopropyl alcohol may be present in an amount from 4% to 10% by weight, particularly from 6% to 8% by weight. The oleic acid may be present in an amount of from 3% to 9% by weight, particularly from 5% to 7% by weight. The lauric acid may be present in an amount from 1% to 3% by weight, particularly from 1.5% to 2.5% by weight. The triethyl citrate may be present in an amount from 1% to 2% by weight, particularly from 1.25% to 1.75% by weight. The ethyl lactate may be present in an amount from 0.5% to 1.5% by weight, particularly from 0.75% to 1.25% by weight. The vanillin may be present in an amount of 0.2 to 0.4% by weight, particularly from 0.29% to 0.31% by weight. The weight percentages are based on a total weight of the composition.

The insect repellant formulation may be prepared into a liquid, such as a clear liquid, for treatment of the affected area (e.g., by spraying).

The insect repellent formulation may be useful to treat barn animals (e.g., horses, cats, dogs, goats, cows, etc.) to provide protection from biting insects and ticks. The insect repellant formulation or composition is eco-friendly, long lasting and is pyrethrin-free and DEET-free and can be sprayed directly on the animal without worry of harm for you or the animal. The formulation does not use harsh chemicals and is made of natural eco-friendly ingredients.

The composition (formulation) may be made according to the following method.

The white mineral oil may be heated from room temperature to 145 to 160 degrees F. in a mixing vat under agitation. Next, the oleic acid and triethyl citrate are added with a temperature controlled to 145 to 150 degrees F., and, while the temperature is maintained at 145 to 150 degrees F., then the isopropyl myristate, vanillin, and lauric acid are added while under agitation. The isopropyl myristate, vanillin, and lauric acid may be added sequentially (in separate steps), or together collectively with or without the oleic acid. Next, the isopropyl alcohol is added once the temperature cools to 110 to 125 degrees F. The composition is maintained under agitation. At this time, a shearing mechanism is activated and maintained until the mixture contains no grit. Next, the geraniol, clove oil, peppermint oil, rosemary oil, and ethyl lactate are added and a shear mechanism is activated and the composition cools to about 110 degrees F. The composition is agitated and sheared for a specified time dependent upon the size of the batch until the composition contains no grit. The composition may then be packaged into a spray bottle or the like for use.

The shearing step is critical to achieving a uniform, grit-free composition with desirable consistency and aesthetic properties for topical application. Shear mixing promotes homogeneous dispersion of both active and inert ingredients, reducing phase separation and ensuring that volatile components such as geraniol and peppermint oil are effectively incorporated throughout the formulation. The endpoint of the shearing process may be determined visually or through particle size analysis to confirm the absence of grit or visible particulates, which may otherwise affect the sprayability or user acceptance of the final product.

In some embodiments, the formulation may optionally be subjected to pH adjustment using biocompatible buffers or acids to maintain a pH within a physiologically acceptable range (e.g., between about 5.0 and 7.5), particularly for use on animals with sensitive skin. This adjustment may further contribute to ingredient stability and dermal compatibility.

In further embodiments, the finished composition may be passed through a filtration step or subjected to a sterilization process (e.g., UV exposure, steam treatment, or preservative addition) to minimize microbial contamination during storage and use. Such processing may be desirable in applications involving frequent reapplication or open-field use in barns or veterinary settings.

The disclosed insect repellant composition for animals repels and kills flying insects and ticks faster and last longer than DEET-containing insecticides. The duration of effectiveness for the disclosure formulation exceeds that of pyrethroids which evaporate quickly and become non-effective. The disclosed insect repellant composition uses plant based active ingredients in convert with synergistic compounds that prohibit the insects and ticks from using the defense mechanism(s) that have enabled protection from DDT and the family of pyrethroids often used in other insect repellant sprays.

The formulation contains no vegetable oils as carriers (inert ingredient) so rapid oxidation and coloration change does not occur while the composition (e.g., spray) is in storage. No shaking is necessary and the liquid composition is clear so the spray will not stain the animals or clothing.

Test results demonstrated that the insect repellant composition provides a safe, non-toxic insecticide for repelling and exterminating biting insects and ticks. The formulation demonstrates both a higher kill rate and much longer efficacy at killing insects permanently than comparative cypermethrin pesticides, using only plant-based active ingredients.

As used herein, the term non-toxic refers to compositions that do not exhibit acute or chronic toxic effects in mammals, including humans and domestic animals, when used as directed. In particular, the term includes compositions that:
(a) are free from known toxic synthetic active ingredients such as DEET and pyrethrins;
(b) are composed entirely of ingredients that are either naturally derived or classified as Generally Recognized As Safe (GRAS) by the U.S. Food and Drug Administration or commonly accepted in veterinary topical formulations; and
(c) do not cause observable irritation, systemic toxicity, or adverse dermal reactions in target animals under normal application conditions.

In some embodiments, the term non-toxic also includes compositions that have been tested and determined to be safe for repeated topical use on animals such as cats, dogs, horses, and livestock.

Even though the present disclosure has been described in detail with reference to specific examples, it will be appreciated that the various modifications and changes can be made to these examples without departing from the scope of the present disclosure as set forth in the claims. It is anticipated and intended that future developments will occur in the technologies discussed herein, and that the disclosed article and/or assembly will be incorporated into such future developments. Thus, the specification and the drawings are to be regarded as an illustrative thought instead of merely restrictive thought.

It should be understood that references to a single element are not necessarily so limited and may include one or more of such element. Further, all numbers expressing dimensions, ratios and the like, used in the specification and claims, are to be understood to encompass tolerances and other deviations as represented by the term “about” or “approximately.”

The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary. Further, the use of “at least one of” is intended to be inclusive, analogous to the term and/or. As an example, the phrase “at least one of A, B and C” includes A only, B only, C only, or any combination thereof (e.g. AB, AC, BC or ABC). Additionally, use of adjectives such as first, second, etc. should be read to be interchangeable unless a claim recites an explicit limitation to the contrary.

What is claimed is:

1. A topical insect repellent composition for animals, comprising:
active ingredients including geraniol, clove oil, peppermint oil, and rosemary oil; and
inert ingredients including mineral oil, isopropyl myristate, oleic acid, isopropyl alcohol, lauric acid, triethyl citrate, ethyl lactate, and vanillin.

2. The topical insect repellent composition of claim 1, wherein the geraniol is present in an amount of from 2.2% to 6.2% by weight, the clove oil is present in an amount of 1% to 5% by weight, the peppermint oil is present in an amount of from 0.5% to 3.5% by weight, and the rosemary oil is present in an amount of 0.5% to 3.5% by weight.

3. The topical insect repellent composition of claim 2, the geraniol is present in an amount of from 3.2% to 5.2% by weight, the clove oil is present in an amount of 2% to 4% by weight, the peppermint oil is present in an amount of from 1.5% to 2.5% by weight, and the rosemary oil is present in an amount of 1.5% to 2.5% by weight.

4. The topical insect repellent composition of claim 1, wherein the mineral oil is present in an amount of from 33% to 63% by weight, the isopropyl myristate is present in an amount of from 13% to 33% by weight, the isopropyl alcohol is present in an amount from 4% to 10% by weight, the oleic acid is present in an amount of from 3% to 9% by weight, the lauric acid is present in an amount from 1% to 3% by weight, the triethyl citrate is present in an amount from 1% to 2% by weight, the ethyl lactate is present in an amount from 0.5% to 1.5% by weight, and the vanillin is present in an amount from 0.2% to 0.4% by weight.

5. The topical insect repellent composition of claim 4, wherein the mineral oil is present in an amount of from 40% to 60% by weight, the isopropyl myristate is present in an amount of from 17% to 28% by weight, the isopropyl alcohol is present in an amount from 6% to 8% by weight, the oleic acid is present in an amount of from 5% to 7% by weight, the lauric acid is present in an amount from 1.5% to 2.5% by weight, the triethyl citrate is present in an amount from 1.25% to 1.75% by weight, the ethyl lactate is present in an amount from 0.75% to 1.25% by weight, and the vanillin is present in an amount from 0.29% to 0.31% by weight.

6. The topical insect repellent composition of claim 1, in the form of a clear liquid.

7. The topical insect repellent composition of claim 1, wherein the composition is:
(a) free from pyrethrins and DEET;
(b) free from vegetable oils; and
(c) stable in storage without shaking or visible color change.

8. An insect repellent formulation comprising the composition of claim 1, in a sprayable liquid form configured for direct application to animals.

9. The formulation of claim 8, wherein the formulation is stored in a container with a spray nozzle and is stable without agitation.

10. A method of repelling insects on animals, comprising:
applying a spray composition to an animal, the spray composition including active ingredients and inert ingredients;
the active ingredients including geraniol, clove oil, peppermint oil, and rosemary oil; and
the inert ingredients including mineral oil, isopropyl myristate, oleic acid, isopropyl alcohol, lauric acid, triethyl citrate, ethyl lactate, and vanillin.

11. The method of claim 10, wherein the composition remains effective for a duration longer than a DEET- or cypermethrin-based repellent.

12. The method of claim 10, wherein the geraniol is present in an amount of from 2.2% to 6.2% by weight, the clove oil is present in an amount of 1% to 5% by weight, the peppermint oil is present in an amount of from 0.5% to 3.5% by weight, and the rosemary oil is present in an amount of 0.5% to 3.5% by weight.

13. The method of claim 10, wherein the mineral oil is present in an amount of from 33% to 63% by weight, the isopropyl myristate is present in an amount of from 13% to 33% by weight, the isopropyl alcohol is present in an amount from 4% to 10% by weight, the oleic acid is present in an amount of from 3% to 9% by weight, the lauric acid is present in an amount from 1% to 3% by weight, the triethyl citrate is present in an amount from 1% to 2% by weight, the ethyl lactate is present in an amount from 0.5% to 1.5% by weight, and the vanillin is present in an amount from 0.2% to 0.4% by weight.

14. A method of manufacturing a topical insect repellent composition, comprising:
(a) heating mineral oil to about 145° F. to about 160° F. under agitation;
(b) adding oleic acid and triethyl citrate while maintaining the temperature between about 145° F. and 150° F.;
(c) adding isopropyl myristate, vanillin, and lauric acid sequentially or collectively under agitation;
(d) cooling the mixture to about 110° F. to 125° F. and adding isopropyl alcohol under continued agitation;
(e) activating a shearing mechanism until no grit remains;
(f) adding geraniol, clove oil, peppermint oil, rosemary oil, and ethyl lactate; and
(g) continuing shearing and agitation until the composition is clear and homogeneous.

15. The method of claim 14, wherein the resulting composition is free from pyrethrins and DEET.

16. The method of claim 14, wherein the composition is a clear, non-staining liquid that does not require agitation prior to use.
